(19) United States
(12) Patent Application Publication
(10) Pub. No.: US 2009/0077911 A1
(43) Pub. Date: Mar. 26, 2009

(54) Frame for an opening and related method

(76) Inventor: Michael Dove, Mission Viejo, CA (US)

Correspondence Address: Michael J. Dove, 24115 Lindley Street, Mission Viejo, CA, 92691, US

(21) Appl. No.: 11/904,014

(22) Filed: Sep. 25, 2007

(51) Int. Cl. E06B 1/04

(52) U.S. Cl. 52/213; 29/897.312; 49/504

(57) ABSTRACT

One embodiment the device described herein relates to a frame for an opening defined by a plurality of sidewalls formed in a structure having one of a door or a window disposed within the opening. The frame including one or more seamless frame members formed from a single piece of metal, the one or more frame members including: (1) an open-well configured to receive a sealing means disposed therein for sealing with one of a front or a back surface of the one of a door or a window; (2) an abutting structure position between the sidewall and the lateral portion of the one of the door or the window, and forming a portion of the open-well; and (3) a casing positioned to be viewed from one side of the opening, the casing connecting the open-well and the abutting structure.

### TECHNICAL FIELDS

The disclosure herein relates to framed openings, and more particularly to a frame for an opening for a door or a window, the frame including one or more frame members having a single-piece construction and further including, among other things, an open-well configured to receive a sealing means disposed therein for sealing with the door or window.

### BACKGROUND

New construction or renovation/remold projects often require the framing of openings such as entry and exit points, for example, those for a door and/or a window. When installing a frame into an opening it is desirable to have a strong, durable frame that is prefabricated or easily assembled on the job site. Framing for openings are varied in design and construction, but are generally fabricated from wood or metal and are configured to frame along an inside portion and an outside portion of the opening's perimeter while retaining a closure device such as a door or window disposed between the framing.

Although existing frames for openings are generally well suited for their intended purpose, further refinement to the design, manufacture, and use of the frame for improved retention and sealing characteristics, durability and structural integrity is desirable.

Accordingly, there exists a need for a frame for an opening, the frame including one or more frame members having a single-piece construction and further including, among other things, an open-well configured to retain a sealing means disposed therein for sealing with a closure device such as a door or window.

### SUMMARY

For the purpose of summarizing the invention certain objects and advantages have been described. It is to be understood that not all such objects or advantages may be achieved in accordance with any particular embodiment. Thus, for example, those skilled in the art will recognize that the device described herein may be embodied or carried out in a manner that achieves or optimizes one advantage or group of advantages as taught herein without necessarily achieving other objects or advantages.

In one embodiment the disclosed subject matter includes a frame for an opening, the frame comprising one or more frame members formed from a single piece of material, the one or more frame members including an open-well configured to receive a sealing means disposed therein for sealing with a closure device such as a door or a window.

In one embodiment the disclosed subject matter includes a frame for an opening formed within a structure having one of a door or a window disposed within the opening. The frame including one or more frame members formed from a single piece of metal, the one or more frame members including: (1) an open-well configured to receive a sealing means disposed therein for sealing with the face of the one of a door or a window; (2) an abutting structure position between the sidewall and the lateral portion of the one of the door or the window, and forming a portion of the open-well; and (3) a casing positioned to be viewed from one side of the opening, the casing connecting the open-well and the abutting structure.

In one embodiment the disclosed subject matter includes a method for forming a frame for an opening, comprising the step(s) of bending one or more frame members from a single-piece of material, the one or more frame members including an open-well configured to receive a sealing means disposed therein for sealing with a closure device such as a door or a window.

These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a perspective view of an opening having a closure device (door) retained within the opening and sealed with a frame having one or more frame members in accordance with one embodiment.

FIG. 2 is a front view of the opening having a closure device (door) retained within the opening and sealed with the frame of FIG. 1 in accordance with one embodiment.

FIG. 3 is a side cross-sectional view of a door retained in an opening by a header of the frame of FIG. 1, the header positioned between the top of the door and an upper bulkhead in accordance with one embodiment.

FIG. 4 is a top cross-sectional view of a door retained in an opening between a first side piece and a second side piece of the frame of FIG. 1, the first and second side pieces positioned between the door and corresponding first and second support sidewalls in accordance with one embodiment.

FIG. 5 is an enlarged view of the second side piece of the frame of FIG. 4 in accordance with one embodiment.

### DETAILED DESCRIPTION

Exemplary embodiments will now be described with references to the accompanying Figures, with like reference numerals referring to like elements throughout. The terminology used in the description is not intended to be interpreted in any limited or restrictive manner, simply because it is being utilized in conjunction with a detailed description of certain embodiments. Furthermore, various embodiments (whether or not specifically described herein) may include novel features, no single one of which is solely responsible for its desirable attributes or which is essential to practicing the subject matter described herein.

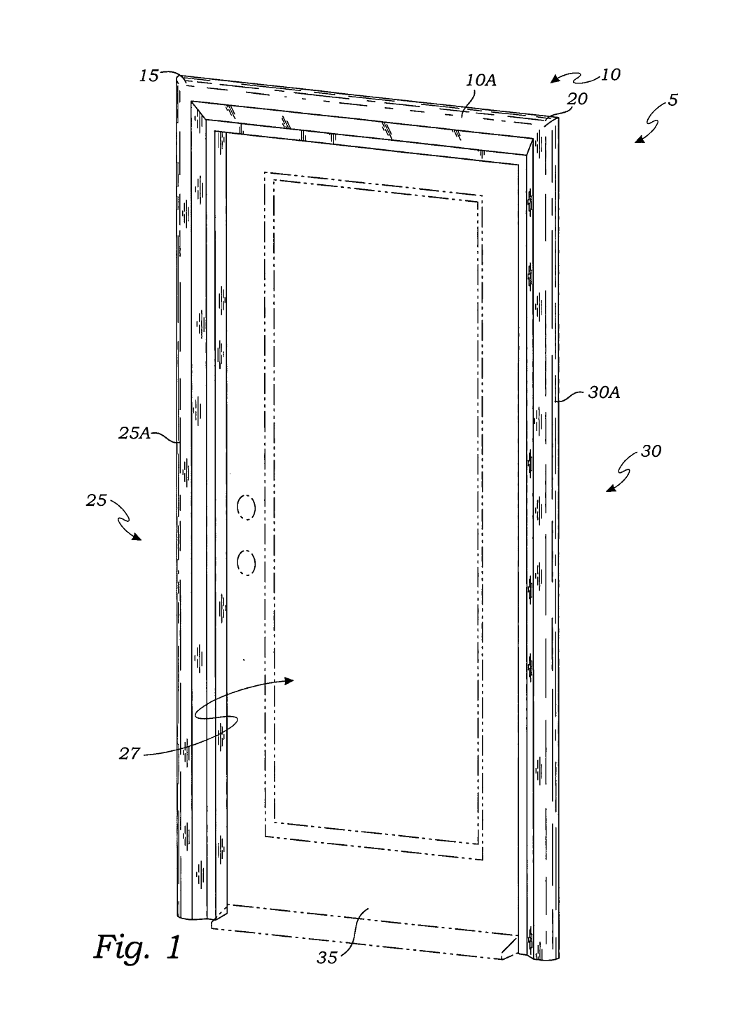

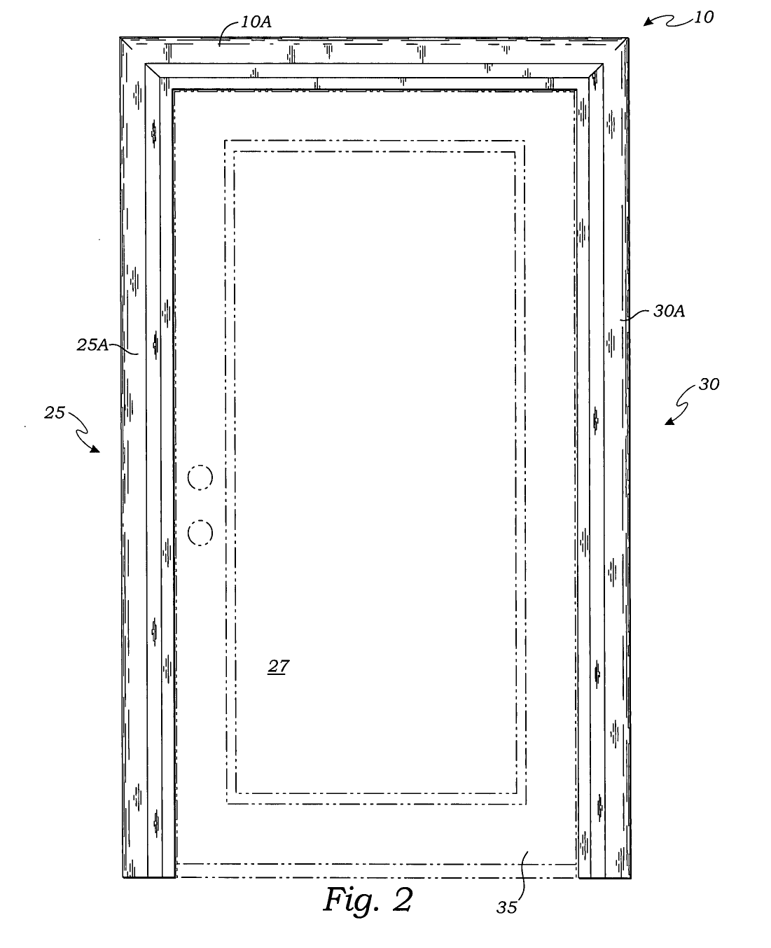

FIG. 1 is a perspective view and FIG. 2 is a front view of an opening having a closure device (door) retained within the opening and sealed with a frame having one or more frame members in accordance with one embodiment. As shown in FIGS. 1 and 2, in one embodiment the frame 5 is preferably of a single-piece metal construction and includes one or more frame members including a header 10 having a first end 15 and a second end 20, a first side piece 25, and a second side piece 30. The first side piece 25 is provided for attachment to the first end 15, and the second side piece 30 is provided for attachment to the second end 20. Attachment of the first side piece 25 and second side piece 30 to the first end 15 and second end 20 respectively may be accomplished by tack welding, soldering, or a similar method for joining metal pieces. Accordingly, once joined together the header 10, first side piece 25, and second side piece 30 define a frame 5 for retaining and sealing a closure device 27 such as a door 35 or window 36 within an opening.

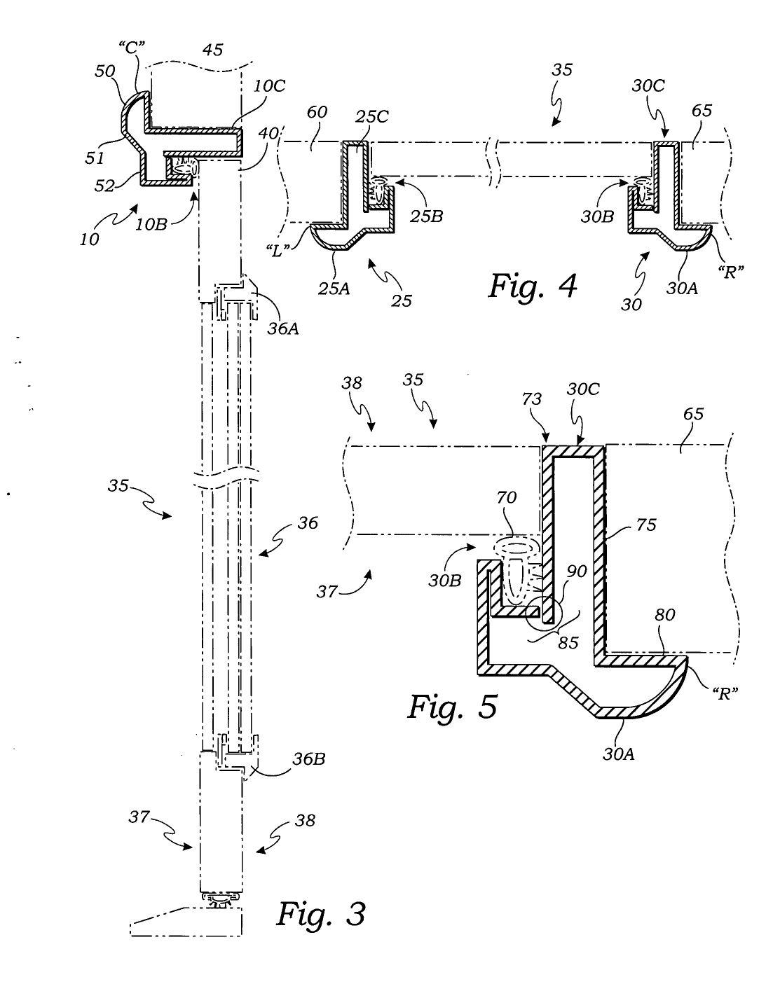

Although the frame 5 is described herein as it relates to an opening for a door 35, persons of ordinary skill in the art will understand that the term “opening” as used herein is a broad term and is meant to include an opening for both ingress and egress. In other words, if an object such as a person, animal, or item can enter through the opening it is generally understood that the object can exit through the opening. Accordingly, a frame5 having at least one frame member 10, 25, 30 as described here may be utilized to retain and seal with a window 36 such as one that is retained and sealed within a door 35, as shown in FIG. 3. In this regard, it is understood that the frame members 36A, 36B shown positioned at the top and bottom of the window 36 shown in FIG. 3 are substantially the same as the frame members 10, 25, 35 described herein relating to the framing of a door 35 and preferably include an open-well configured to receive a sealing means disposed therein for sealing with the window 36.

In addition, it is understood that the frame 5 described herein may be in an opening where entrance and exit from the opening is not intended such as would be the case in an upper level window. Furthermore, persons of ordinary skill in the art will understand that materials other than metal, such as plastic and/or carbon fiber, to name a few, may be appropriate and utilized within the spirit and teachings of the disclosure provided herein.

As further shown in FIGS. 1 and 2, and more particularly in FIGS. 3-5, the one or more of the frame members including the header 10, and first and second side pieces 25, 30 each preferably include a casing or molding 10A, 25A, 30A that may be provided in a variety of shapes, depending on, among other things, style preference, to provide, among other things, a finished appearance to the frame 5 when viewed from one side of the frame 5 by bending the metal either by hand, the aid of a metal press, or similar type device. For example, in FIG. 3, a side cross-sectional view of a door 35 retained in an opening by a header 10 positioned between the top 40 of the door 35 and an upper bulkhead 45, the casing or molding 10A of the header 10 has a curved section 50 that begins at an upper bulkhead 45 at designated reference point “C”, curves downward to meet a section 51 angled at about forty-five degrees in a direction toward the door 35, and continues down a length 52 in a direction parallel to the upright door 35. Persons of ordinary skill in the art will understand that a multitude of other casing or molding 10A shapes may be utilized with one or more of the frame members 10, 25, 30 in accordance with one embodiment.

FIG. 4 shows a top cross-sectional view of a door 35 retained in an opening between the first side piece 25 and a second side piece 30 of the frame 5 in accordance with one embodiment, while FIG. 5 is an enlarged view of the second side piece 30 of FIG. 4. As shown in the figures, the header 10, first side piece 25, and second side piece 30 are configured to have substantially the same size and shape. Accordingly, the first or left side piece 25 and second or right side piece 30 are interchangeable by simply flipping the left side piece 25 over for proper alignment and placement against a right sidewall 65, or flipping the right side piece 30 over for proper alignment and placement against a left sidewall 60. Similarly, either the right side piece 25 or left side piece 30 may be reduced in length by cutting or similar method for use as a header 10 in accordance with one embodiment.

As indicated above, the frame members, i.e., the header 10 and first and second side pieces 25, 30, each preferably include a casing or molding 10A, 25A, 30A that may be provided in a variety of shapes. As further indicated above, the casing or molding 10A of the header 10 begins at the upper bulkhead as referenced by point “C” and is shaped to extend toward the opening where the door 35 is retained therein. Similarly, as shown in FIG. 4 and FIG. 5, the casing or molding 25A, 30A of each of the left and right side pieces 25, 30 begin at a corresponding left or right sidewall 60, 65, typically, but limited to a support structure, or similar object, as referenced by points “L” and “R” respectively and are shaped to extend toward the opening where the door 35 is retained therein.

Each frame member 10, 25, 30 includes an open-well 10B, 25B, 30B shaped and configured to receive a gasket 70 or similar sealing element or compound such that the gasket 70 is retained within the open-well 10B, 25B, 30B while contacting a face 37, 38 of the door 35, i.e., either the front or back surface, thus providing a seal between exterior or outside environment relative to the opening and the interior or inside environment relative to the opening. As such, the frame members 10, 25, 30 in accordance with one embodiment may provide sealing along at least three sides of a door 35 and four sides of a window 36. Persons of ordinary skill in the art will understand that embodiments of the frame described herein may be applicable to doors and/or window of various shape including, for example, a hexagon shaped window such as those used for portal similar to those used on water vessels.

Preferably, the open-well 30B is formed by bending the metal by hand, with the aid of a metal press, or similar device to form a three-sided pocket 85 for receiving the gasket 70. The open-well 30B is configured with sufficient width and depth to retain the gasket 70 within the pocket 85 of the open-well 30B while permitting the gasket 70 to protrude from the pocket 85 to seal with the door 35 when the door 35 in a closed position, as shown in FIG. 5.

Each frame member 10, 25, 30 is further bent or formed by one or more of the methods described above to include an abutting structure 10C, 25C, 30C that extends from the casing or molding 10A, 25A, 30A, contacts a sidewall 45, 60, 65 (upper bulkhead, left sidewall or right sidewall) that define a portion of the opening, borders a lateral portion 73 (top, bottom, right or left side) of the closure device 27, and forms a portion of the pocket 85 of the open-well 10B, 25B, 30B. For example, as shown FIG. 5, the abutting structure 30C of the right side piece 30 includes a main body 75 having a generally rectangular shape to provide proper spacing between the right sidewall 65 and the door 35, and further includes a portion 80 that extends perpendicular to the main body 75 for further contacting the right sidewall 65 while connecting the main body 75 to the casing or molding 30A. Persons of ordinary skill in the art will understand that the main body 75 of one or more of the frame members 10, 25, 30 may be provided in a variety of shapes within the spirit and teachings of the disclosure, i.e., a frame member having a single-piece construction including an open-well configured to receive a sealing means disposed therein for sealing with a closure device such as a door or window.

As indicated above and shown in at least FIG. 5, the frame members 10, 25, 30 are preferably formed or configured by bending or otherwise manipulating a single-piece of metal to form various elements of the frame member including the casing 10A, 25A, 30A, open-well 10B, 25B, 30B, and abutting structure 10C, 25C, 30C. As such, the forming process or method results in a seamless frame member void of welds or other joint areas where separate pieces are connected together. In this regard, in one embodiment, the frame member 10, 25, 30 preferably includes a gap or space 90 between the portion of the abutting structure 10C, 25C, 30C that forms the open-well and the open-well 10B, 25B, 30B. This space permits the frame member 10, 25, 30 to flex to facilitate positioning of the frame member 10, 25, 30 in areas (between and along sidewalls) that are not square, sized irregularly, or otherwise have some sort of structural problem that must be compensated for during installation of the one or more frame members 10, 25, 30.

Persons of ordinary skill in the art will understand that the term “sidewall” is a broad term intended to include those elements, i.e., a plurality of sidewalls, formed in a structure (any professional, residential, recreational, storage dwelling) that generally define an opening for a door or window and may include structural support elements and non-structural support elements located about the periphery of the opening regardless of whether the element is considered a right or left sidewall, upper portion such as a bulkhead, or lower portion such as a footing.

In accordance with one embodiment, a method for forming a frame for an opening includes bending one or more frame member from a single piece of material such as metal, the one or more frame members including an open-well configured to receive a sealing means disposed therein for sealing with a closure device such as a door or window retained within the opening. The method further includes forming the open-well to include a three-sided pocket configured to retain the sealing means, a portion of the sealing means protruding from the pocket to seal with the closure device.

The apparatus and methods of the present invention have been described with some particularity, but the specific designs, constructions and steps disclosed are not to be taken as delimiting of the invention. Obvious modifications will make themselves apparent to those of ordinary skill in the art, all of which will not depart from the essence of the invention and all such changes and modifications are intended to be encompassed within the appended claims.

What is claimed is:

1. A frame for an opening defined by a plurality of sidewalls formed in a structure having a closure device disposed within the opening, the frame comprising:
one or more frame members formed from a single piece of material, the one or more frame members connected to one sidewall of the plurality of sidewalls, the frame member including an. open-well configured to receive a sealing means disposed therein for sealing with one of a front of a back surface of the closure device positioned within the opening.

2. The frame of claim 1, wherein the one or more frame members are seamless and formed from metal.

3. The frame of claim 1, wherein the closure device is a door.

4. The frame of claim 1, wherein the closure device is a window.

5. The frame of claim 1, wherein the open-well is configured to retain the sealing means, a portion of the sealing means protruding from the open-well to seal with the closure device.

6. The frame of claim 2, wherein the open-well is a three-sided pocket.

7. A method for forming a frame for an opening defined by a plurality of sidewalls formed in a structure having a closure device disposed within the opening, the method comprising the steps of:
forming one or more seamless frame members from a single-piece of metal to include an open-well configured to receive a sealing means disposed therein for sealing with one of a front or a back surface of the closure device positioned within the opening; and
forming an abutting structure to be received between one sidewall of the plurality of sidewalls and a lateral portion of the closure device, the abutting structure forming a portion of the open-well.

8. The method of claim 7, further including the step of forming a casing to be viewed from one side of the opening, the casing connecting the open-well and the abutting structure.

9. The method of claim 7, wherein the step of forming further includes the step of bending the one or more frame members from metal.

10. The method of claim 7, further including the step of configuring the open-well to retain the sealing mean with a portion of the sealing means protruding from the open-well to permit sealing with the closure device.

11. The method of claim 10, wherein the open-well is further configured to form a three-sided pocket.

12. A frame for an opening defined by a plurality of sidewalls formed in a structure having one of a door or a window disposed within the opening, the frame comprising:
one or more frame members formed from a single piece of metal, the one or more frame members including:
an open-well configured to receive a sealing means disposed therein for sealing with one of a front or back surface of the one of a door or a window;
an abutting structure position between one sidewall of the plurality of sidewalls and a lateral portion of the one of the door or the window, and forming a portion of the open-well; and
a casing positioned to be viewed from one side of the opening, the casing connecting the open-well and the abutting structure.

13. The frame of claim 12, wherein the open-well is configured to retain the sealing means, a portion of the sealing means protruding from the open-well to seal with the one of the door or the window.

14. The frame of claim 12, wherein the one or more frame members are seamless.
